(19) United States
(12) Patent Application Publication
(10) Pub. No.: US 2007/0229227 A1
(43) Pub. Date: Oct. 4, 2007

(54) METHOD AND APPARATUS FOR PROVIDING REJUVENATED TRANSPONDERS

(75) Inventor: ANTHONY R. BROWN, Spring Grove, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/682,577

(22) Filed: Mar. 6, 2007

Related U.S. Application Data
(60) Provisional application No. 60/779,977, filed on Mar. 7, 2006.

(51) Int. Cl. H04Q 5/22

(52) U.S. Cl. 340/10.6; 340/10.5; 324/500; 702/81; 340/572.1; 340/10.51

(57) ABSTRACT

The present invention provides a transponder communication system that is capable of reading and/or encoding transponders such that a user may increase the output of operable smart media units. In particular, the transponder communication system is capable of rejuvenating otherwise unusable smart media units by allowing a user to choose to have the smart media printer continue communicating with a transponder even after a previously unsuccessful communication. The transponder communication system also displays RFID data to a user, thus allowing a user to determine whether the proper RFID data was communicated to the smart media unit. A related computer program product and a related method are also provided.

### CROSS-REFERENCE TO RELATED APPLICATIONS

This application claims priority from U.S. Provisional Application No. 60/779,977, filed Mar. 7, 2006, which is hereby incorporated herein in its entirety by reference.

### BACKGROUND OF THE INVENTION

1. Field of the Invention

The present invention is related to the printing and encoding of media with embedded transponders and more particularly, to transponder communication systems and methods that produce operable smart media output.

2. Description of the Related Art

RFID technology provides efficient, instantaneous communication between a reader and an RFID transponder without directed near field scanning as is commonly required in more conventional automatic identification technologies (e.g., bar-code, optical scanning, etc.). The use of Electronic Article Surveillance, Radio Frequency Identification, and electronic security tag technology (hereinafter collectively referred to as ‘RFID’) is becoming increasingly prevalent in commercial, industrial, retail, and personal-use settings. RFID technology involves the transmission of information through electromagnetic waves.

It has become increasingly common to provide RFID labeling for commercial, industrial, and retail products that combines the presentation of human and machine readable information into a single media unit (e.g., a label). In this regard, RFID printing systems have been developed that associate human and machine readable information with the media units. A typical RFID printer system includes a transponder interface that is adapted to encode, read, test, or otherwise communicate with an RFID transponder attached to or embedded within a media unit. The RFID printer system also includes a printer assembly for printing human readable information (e.g., text, graphics, etc.) on the media unit.

RFID transponders generally include a circuit chip and an antenna attached to the circuit chip. The circuit chip and antenna are generally thin, flexible, and mounted to a flexible dielectric substrate. Antennas have numerous configurations and each is structured generally to broadcast electromagnetic energy to a distant transponder interface. RFID transponders can be programmed to store a variety of information. For example, RFID transponders often include retail product identification such as a product serial number or manufacturer's code. RFID transponders may also include identifying or verifying information thereby reporting the identity of an article or the identity associated with a person carrying the article.

As one might expect, RFID printer systems commonly process media units in bulk. Given packaging restrictions, the media units are loaded in rolls, stacks, or other formats in which the RFID transponders are closely spaced. Close spacing of the RFID transponders adds difficulty to the task of serially communicating with each RFID transponder without simultaneously communicating with RFID transponders disposed on neighboring media units. Targeted communication with a selected transponder is also made more difficult given that RFID printer systems often perform printing and encoding steps in close proximity to one another. Thus, transponders provided on media units that are being printed may inadvertently receive encoding instruction meant for transponders disposed on media units at adjacent encoding locations.

In view of the above, transponder communication systems have been developed having the ability to interrogate, with relative spatial selectivity, a targeted RFID transponder from a plurality of adjacently located RFID transponders. The task of such systems is made more difficult by virtue of the fact that RFID transponders have different sizes, shapes and coupling characteristics. The communication systems themselves must also be able to accommodate media units of differing types, sizes, shapes, and transponder locations.

Despite recent developments in this area, the possibility remains that a transponder communication system will not successfully communicate with a targeted RFID transponder. Alternatively, such systems may inadvertently communicate with other non-targeted transponders. In addition, RFID transponders themselves may have defects that result in corruption of certain encoded information. Any one of the above problems may interrupt the efficient operation of the transponder communication system.

Existing transponder communication systems may attempt to test communication with a transponder by performing a communication procedure. One such communication procedure is shown in FIG. 1. According to the depicted procedure, in a first step, a transponder communication system attempts to read an RFID transponder (block 10) located on a media unit. If the read step is successful, the test proceeds to a write step (block 13). However, if the read step is unsuccessful, the test ends (block 12). After an unsuccessful read step, an error message may be conveyed to indicate to a user that the RFID transponder is unusable. If the write step is successful, the test proceeds to a verify step (block 16). However, if the write step is unsuccessful, the test ends (block 15). Likewise, an error message may also be conveyed to indicate to a user that the RFID transponder is unusable. If the verify step (block 16) is successful, the test ends with an operable RFID transponder that has been successfully encoded. After successful encoding, an affirming message may be conveyed to indicate to a user that the RFID transponder was successfully encoded. However, if the verify step (block 16) is unsuccessful, the test ends (block 18), and a similar error message may be displayed to indicate to a user that the RFID transponder is unusable.

Typically, if an RFID transponder does not pass any of the read, write, or verify steps, the entire media unit is discarded and the encoding or interrogation process continues on subsequent media units until successful communication is accomplished. This process is highly inefficient and results in wasted resources, namely, unusable media units. In addition, it provides no opportunity for a user to “fix” or facilitate successful communication between the transponder communication system and an RFID transponder when previous communication attempts have failed. Thus, the number of operable smart media units is decreased and the user is left with a large quantity of non-operative media units.

Therefore, it would be advantageous to provide a computer program product, a transponder communication system, and a method that are capable of efficiently increasing the number of successful communications between the transponder communication system and the plurality of transponders it processes.

### BRIEF SUMMARY OF THE INVENTION

In one embodiment, the present invention addresses the above needs and achieves other advantages by providing a computer program product for testing the communication between a transponder interface and a transponder. In general, the computer program product may include a first executable portion for performing a first communication with the transponder, a second executable portion for displaying whether or not the first communication was successful, and a third executable portion for allowing a user to proceed to a second communication with the transponder. In various embodiments, the first and second communications may comprise reading, writing, verifying, and/or restoring RFID data to the transponder.

In another embodiment, the present invention provides a transponder communication system for providing operable smart media output. The transponder communication system may include a user interface assembly and a transponder interface. The transponder interface may comprise a transponder encoder for programming the transponder, and a transponder reader for reading the transponder. In one embodiment, the user interface assembly is configured to communicate with the transponder interface to re-communicate with the transponder. The transponder communication system may also include a transponder control assembly, such that the user interface assembly is configured to communicate with the transponder control assembly to re-communicate with the transponder. In one aspect, the user interface assembly may communicate with the transponder interface to re-communicate with the transponder in response to a command entered by a user from the user interface assembly, which may include a display unit that is configured to display RFID data received from the transponder. The display unit may also display communication errors communicated by the transponder interface. The RFID data received from the transponder may be displayed on the display unit in raw format, such as HEX format. The user interface assembly may also include at least a user interface panel that is configured to receive commands from the user. A printhead assembly and a printhead control assembly may also be included for providing printed smart media output.

In another embodiment, the present invention provides a method for providing a user with smart media output that includes a transponder and a media unit. The method comprises communicating with the transponder via a transponder interface, displaying RFID data received from the transponder on a display unit of a user interface assembly, and re-communicating with the transponder in response to at least one command received from the user interface assembly. The method may display raw RFID data on the display unit, and the raw RFID data may be displayed in HEX format. The step of re-communicating with the transponder may comprise at least one of reading, writing, restoring, and verifying RFID data, and this step may occur in response to at least one command entered by a user on a user interface panel of the user interface assembly. Communication errors may also be displayed on the display unit when the step of communicating with the transponder is not successful.

### BRIEF DESCRIPTION OF THE DRAWINGS

The objects and advantages of the present invention will become more readily apparent to those of ordinary skill in the relevant art after reviewing the following detailed description and accompanying drawings, wherein:

FIG. 1 is a flow chart showing an RFID test in accordance with the prior art.

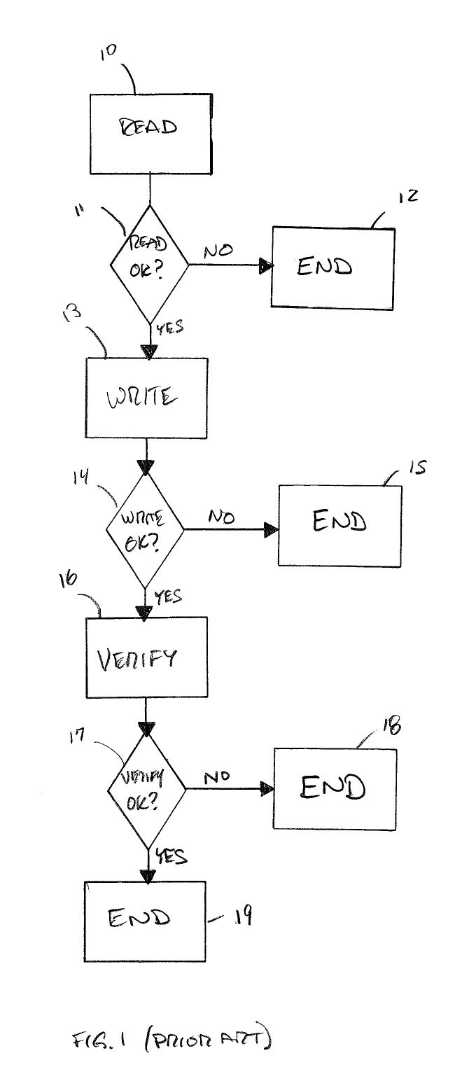

FIG. 2 is a perspective view of an RFID system in accordance with one embodiment of the present invention;

FIG. 3 is a side schematic view of an RFID printer system having a supply of unprogrammed smart media, a transponder encoder, a transponder reader and a printhead assembly in accordance with the embodiment of the present invention depicted in FIG. 2;

FIG. 4 is an isolated block diagram of an RFID printer system in accordance with one embodiment of the present invention; and

FIG. 5 is a flow chart showing an RFID test in accordance with one embodiment of the present invention.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

As will be apparent to one of ordinary skill in the art, transponder communication systems according to various embodiments of the present invention may be adapted for use in any application where it is useful to communicate with media units having transponders embedded or attached thereto. As such, and for the purpose of the current specification, a “media unit” may comprise any item that may be interrogated by a transponder communication system, including but not limited to paper, card stock, labels, transponders, substrate cards, photographic paper, etc.

For purposes of the current specification and appended claims the term “transponder” refers to any device that includes a memory and an apparatus for communicating remotely with a transponder interface, such as remotely detectable tags that incorporate RFID transponders, or other similar technologies. For example, transponders may include RFID transponders, Electronic Article Surveillance (EAS) devices, magnetic tags, smart cards, optical communication tags, capacitive tags, and the like.

Also, for purposes of the current specification and appended claims, the term “RFID data” refers to any data, instructions, or other information of any type, form, or subject matter that can be transmitted to or from a transponder. For example, RFID data may include, but is not limited to, a product serial number, manufacturer's information, a user's security code, employee number, information used to control a consumer product, commands, calibration information, executable code, data, and the like.

From among the various types of transponder communication systems, the applicant has chosen to discuss smart label printers merely for illustration purposes. Moreover, the present invention may encompass any type of transponder communication system and, thus, the current description should not be construed as limiting.

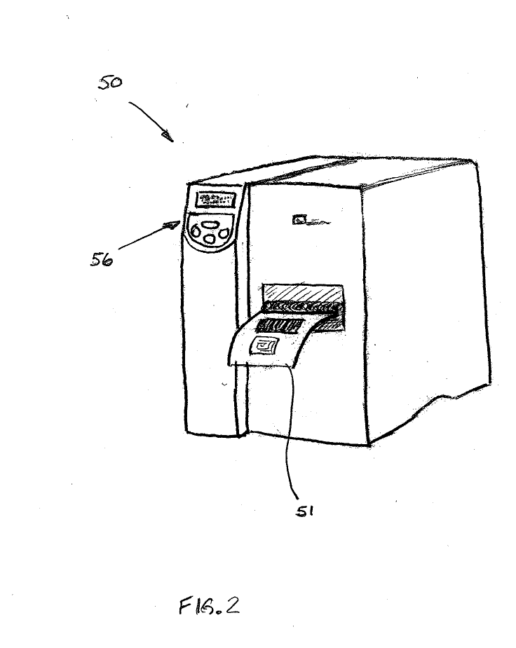

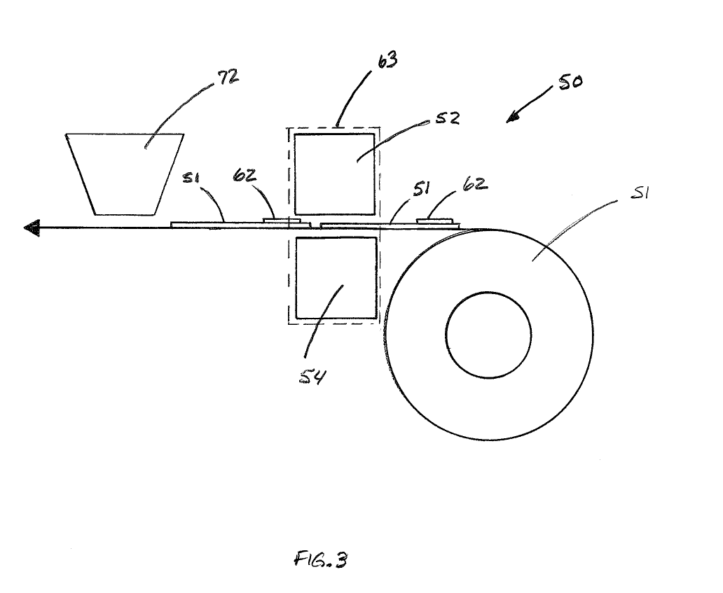

FIGS. 2-4 show a smart label printer 50 configured to produce smart labels. The smart label printer 50 includes a user interface assembly 56 in accordance with one embodiment of the present invention. FIG. 3 is a side schematic view of a smart label printer 50 having supply of media units 51, a transponder interface 63 comprising a transponder encoder 52 and a transponder reader 54, and a printhead assembly 72 in accordance with one embodiment of the present invention. It should be noted that although the depicted embodiment shows the printhead assembly 72 located downstream of the transponder encoder 52 and the transponder reader 54, smart media printers of various embodiments may include the printhead assembly 72 at various locations, including upstream of the encoder 52 and/or the reader 54. It should also be noted that other embodiments of the present invention need not include a printhead assembly. Additionally, although the depicted embodiment shows a transponder interface 63 comprising both a transponder encoder 52 and a transponder reader 54, in other embodiments, the transponder interface 63 may comprise one or the other, or both, and may also comprise a single unit that performs both a reading function and an encoding function.

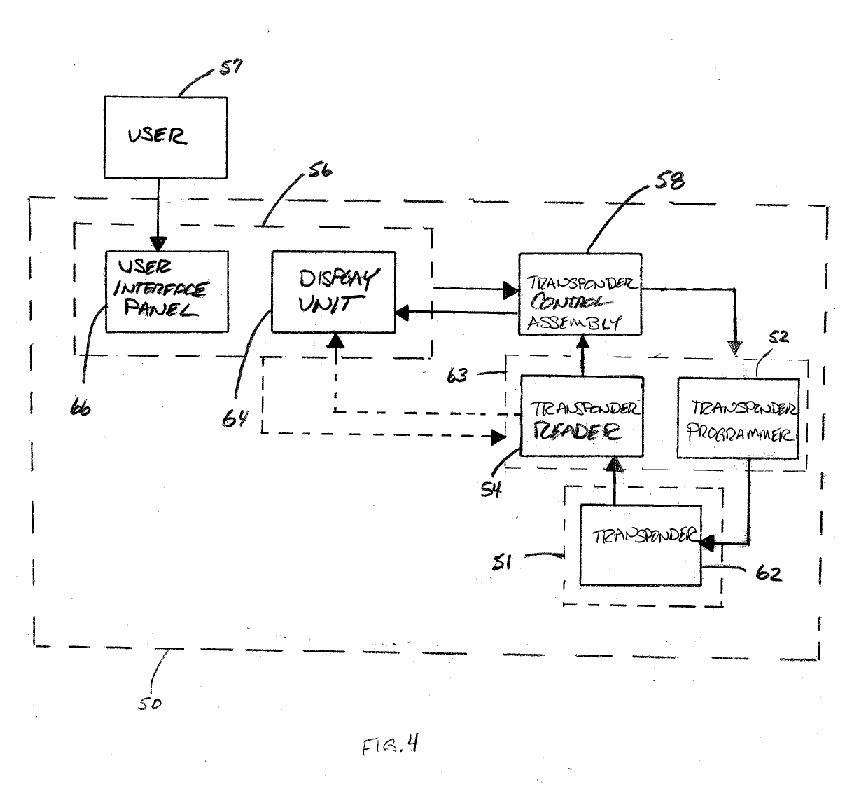

FIG. 4 is an isolated block diagram of the smart label printer 50 in accordance with one embodiment of the present invention. In the depicted embodiment, a user interface assembly 56 includes a user interface panel 66 and a display unit 64. In various embodiments, the user interface panel 56 may include one or more user activated buttons, such as a “Program” button and/or a “Continue” button, as is commonly known in the art. In the depicted embodiment, the display unit 64 is an alpha numeric digital electronic display of a type commonly used in printer systems, and the user interface panel 66 is a user activatable keypad of a type commonly used in printer systems.

In the depicted embodiment, the user interface assembly 56 is configured to communicate with a transponder control assembly 58. The transponder control assembly 58 is configured to communicate with a transponder interface 63 comprising a transponder encoder 52 and a transponder reader 54. Both the transponder encoder 52 and the transponder reader 54 are configured to communicate with a transponder 62 embedded, attached to, carried by, or otherwise associated with a media unit 51. In alternative embodiments of the present invention, the transponder reader 54 and the transponder encoder 52 may be integrated into a single component such as an integrated UHF reader/encoder as is commonly known in the art. It should also be noted that in other embodiments, the user interface assembly 56 may communicate directly with the transponder interface 63 and vice versa, as indicated by the dashed arrows in FIG. 4.

Referring to FIG. 3, during operation of the smart label printer 50, media units 51 travel in the direction of the arrow such that they pass proximate to the transponder interface 63. A printhead assembly 72 is located downstream of the transponder interface 63 such that media units 51 travel proximate the printhead assembly 72 prior to exiting the smart media printer. The transponder encoder 52 is configured to communicate with the transponder 62 on the media unit 51. In one embodiment, the transponder encoder 52 encodes RFID data into the memory of the transponder 62. Subsequently, the transponder 62 is read by the transponder reader 54 in order to verify that the intended RFID data has been properly encoded into the memory of the transponder 62. In one embodiment, the transponder reader 54 may read the information encoded by the transponder encoder, followed by a cyclic redundancy check (‘CRC’) that is intended to verify that all of the bytes of data that should have been encoded into the memory of the transponder 62 have in fact been encoded. A failed CRC is indicative that the intended RFID data was not properly written to the memory of the transponder 62. In the event that transponder reader is able to verify that RFID data has been properly encoded into the memory of the transponder 62, for example when the CRC is successful, the RFID data retrieved from the transponder 62 may be displayed on the display unit of the of user interface assembly 56 in raw format. In one embodiment of the present invention, the RFID data retrieved from the transponder 62 of the smart media unit 51 is displayed in HEX format. It should be noted that there are many identification standards for use in handling RFID data, including GTIN (Global Trade Item Number), SSCC (Serial Shipping Container Code), SGLN (Serialized Global Location Number), etc. By providing the RFID data in HEX format, the present invention allows raw data to be viewed regardless of the standard intended for the transponder.

In the event that the transponder reader 54 is unable to retrieve information from the transponder 62, the transponder reader is configured to communicate with the user interface assembly 56. In such a case, the transponder reader 54 may communicate with the display unit 64 such that an error message is displayed on the display unit 64 of the user interface assembly 56 that is indicative of a failed CRC. In various embodiments, the display unit may display any form of text or other indicia that indicates to a user that the transponder reader 54 was unable to verify the RFID data of the transponder 62. In those embodiments where the display unit is configured to display the RFID data of the transponder 62 in HEX format, the display unit may display “00000000,” thus indicating a CRC error.

In various embodiments, it has been determined that transponders may be revived by forcing an additional communication after a previous communication has failed. In one embodiment of the present invention, a user reading a message that the transponder 62 of the smart media unit 51 is not properly encoded may activate a button or a combination of buttons on the user interface panel 66 that will communicate a command to the transponder control assembly 58 to re-communicate with the transponder 62 of the media unit 51. Thus, in one embodiment of the present invention, the user interface assembly 56 is configured to accept a command from a user 57 in response to an error message displayed on the display unit of the user interface assembly 56 in order to rejuvenate an otherwise un-programmed media unit 51.

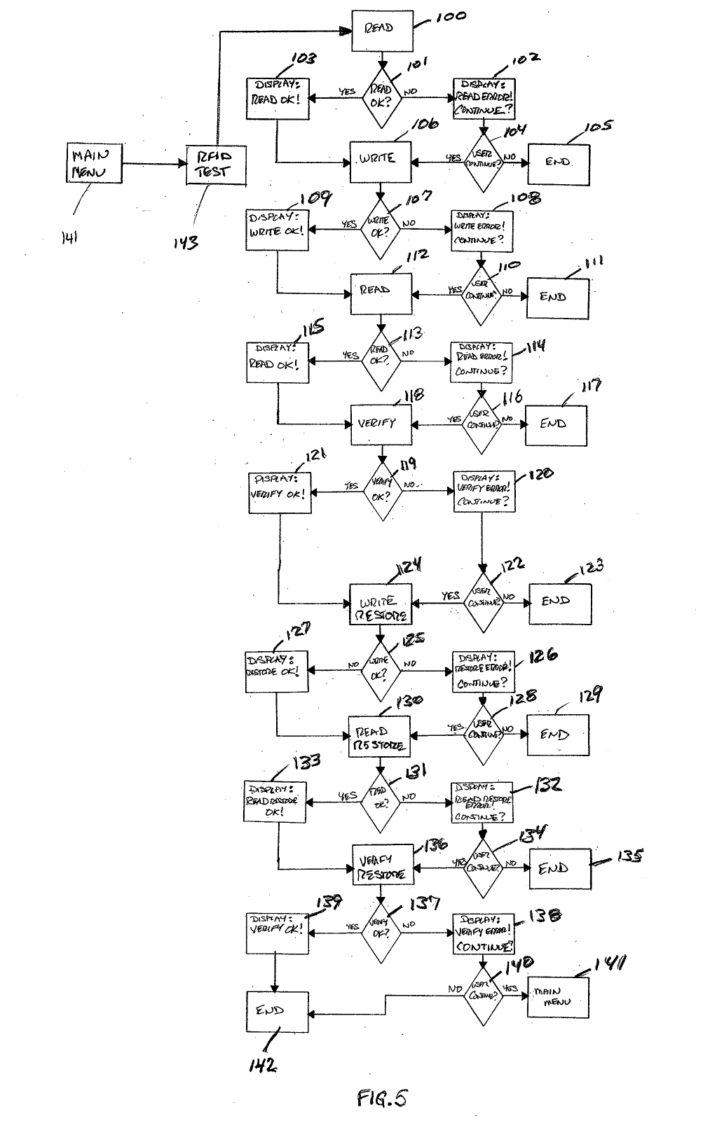

Turning now to the flowchart of FIG. 5 in accordance with one embodiment of the present invention, during operation of a transponder communication system as discussed above, a user may choose an RFID test (block 143) from the main menu (block 141) in accordance with one embodiment of the present invention. The RFID test is a test of the success of communicating with a transponder on a media unit. It should be noted that in the depicted embodiment, the RFID test of the present invention is a test of previously encoded transponders, however in various embodiments, the RFID test may also be used in conjunction with un-programmed transponders. In such cases, the RFID test may perform the initial encoding function.

As a media unit is located proximate a transponder interface, the transponder may be read by a transponder reader (block 100). If the transponder reader successfully reads the transponder, a message may be displayed on a display unit, such message may include an affirming text message, such as “READ OK!” (block 103). After a successful read, a transponder encoder may write to, or encode, the transponder (block 106). If, however, the read is not successful, a negating message may be displayed, such as “READ ERROR!” (block 102). The display unit may also display a continue option for the user, such as by also displaying the message “CONTINUE?” (block 102). At this point the user may be given an option of continuing the process or ending the process (block 104). If the user does not choose to continue, the process ends (block 105).

However, if the user does choose to continue, the process may continue to the write block (block 106). If the transponder encoder successfully writes to the transponder, an affirming message may be displayed on the display unit, such as “WRITE OK!” (block 109). After a successful write, the transponder reader may attempt to read the transponder (block 112). If, however, the write is not successful, a negating message may be displayed, such as “WRITE ERROR!” (block 108). The display unit may also display a continue option for the user, such as by also displaying the message “CONTINUE?” (block 108). At this point the user is given an option of continuing the process or ending the process (block 110). If the user does not choose to continue, the processed ends (block 111).

However, if the user does choose to continue, the process may continue to the read block (block 112). If the transponder reader successfully reads the transponder, an affirming message may be displayed on the display unit, such as “READ OK!” (block 115). After a successful read, a verification step may be performed (block 118). If, however, the read is not successful, a negating message may be displayed, such as “READ ERROR!” (block 114). The display unit may also display a continue option for the user, such as by also displaying the message “CONTINUE?” (block 114). At this point the user is given an option of continuing the process or ending the process (block 116). If the user does not choose to continue, the processed ends (block 117).

However, if the user does choose to continue, the process may continue to the verify block (block 118). If the verification is successful, an affirming message may be displayed on the display unit, such as “VERIFY OK!” (block 121). After a successful verification, the transponder encoder may write to, or encode the transponder (block 124). If, however, the verification is not successful, a negating message may be displayed, such as “VERIFY ERROR!” (block 120). The display unit may also display a continue option for the user, such as by also displaying the message “CONTINUE?” (block 120). At this point the user may be given an option of continuing the process or ending the process (block 122). If the user does not choose to continue, the process ends (block 123).

However, if the user does choose to continue, the process may continue to the write restore block (block 124). If the transponder encoder successfully restores data to the transponder, an affirming message may be displayed on a display unit, such as “RESTORE OK!” (block 127). After a successful restore, the transponder reader may read the transponder (block 130). If, however, the restore is not successful, a negating message may be displayed, such as “RESTORE ERROR!” (block 126). The display unit may also display a continue option for the user, such as by also displaying the message “CONTINUE?” (block 126). At this point the user may be given an option of continuing the process or ending the process (block 128). If the user chooses not to continue, the processed ends (block 129).

However, if the user does choose to continue, the process may continue to the read restore block (block 130). If the transponder reader successfully reads the transponder, an affirming message is displayed on the display unit, such as “READ RESTORE OK!” (block 133). After a successful read restore, a verification step may be performed (block 136). If, however, the read is not successful, a negating message may be displayed, such as “READ RESTORE ERROR!” (block 132). The display unit may also display a continue option for the user, such as by also displaying the message “CONTINUE?” (block 132). At this point the user is given an option of continuing the process or ending the process (block 134). If the user chooses to not continue, the processed ends (block 135).

However, if the user does choose to continue, the process may continue to the verify block (block 136). If the verification is successful, an affirming message may be displayed on a display unit, such as “VERIFICATION OK!” (block 139). After a successful verification, the transponder has been successfully tested and the process ends (block 142). If, however, the verification is not successful, a negating message may be displayed, such as “VERIFY ERROR!” (block 138). The display unit may also display a continue option for the user, such as by also displaying the message “CONTINUE?” (block 138). At this point the user is given an option of continuing the process or ending the process (block 140). If the user chooses to not continue, the processed ends (block 142). However, if the user does choose to continue, the process returns to the main menu (block 141). As a result, the RFID test described above allows multiple opportunities for a user to rejuvenate an otherwise unusable media unit by allowing the user to choose to proceed to any or all of the read, write, and verify steps of the RFID test.

It should be noted that although FIG. 5 is referred to as a flowchart, the term flowchart will be understood to also include a block diagram, flowchart and/or control flow illustration. It should also be understood that each step of the flowchart can be implemented by computer program instructions. These computer program instructions may be loaded onto a computer or other programmable apparatus to produce a machine, such that the instructions that execute on the computer or other programmable apparatus create means for implementing the functions specified in the flowchart step(s).

These computer program instructions may also be stored in a computer-readable memory that can direct a computer or other programmable apparatus to function in a particular manner such that the instructions stored in the computer-readable memory produce an article of manufacture including instruction means that implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart.

Accordingly, steps of the flowchart support combinations of means for performing the specified functions, combinations of steps for performing the specified functions and program instruction means for performing the specified functions. It should also be understood that each step of the flowchart, and combinations of steps in the flowchart can be implemented by special purpose hardware-based computer systems that perform the specified functions or steps, or combinations of special purpose hardware and computer instructions.

The present invention provides a transponder communication system that is capable of communicating with transponders such that a user may increase the output of operable smart media units. In particular, the transponder communication system is capable of rejuvenating otherwise unusable smart media units by allowing a user to choose to have the smart media printer continue communicating with a transponder even after a previously unsuccessful communication. The transponder communication system also displays RFID data to a user, thus allowing a user to determine whether the proper RFID data was communicated to the smart media unit.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer program product for testing the communication between a transponder interface of a transponder communication system and a transponder attached to a media unit, said computer program product comprising:
a first executable portion for performing a first communication with the transponder;
a second executable portion for displaying whether or not the first communication was successful; and
a third executable portion for allowing a user to choose to proceed to a second communication with the transponder.

2. The computer program product of claim 1, wherein the first communication comprises reading RFID data from the transponder.

3. The computer program product of claim 2, wherein the second communication comprises writing RFID data to the transponder.

4. The computer program product of claim 1, wherein the second communication comprises verifying RFID data on the transponder.

5. The computer program product of claim 1, wherein the first communication comprises writing RFID data to the transponder.

6. The computer program product of claim 5, wherein the second communication comprises reading RFID data to the transponder.

7. The computer program product of claim 1, wherein the first communication comprises verifying RFID data on the transponder.

8. The computer program product of claim 7, wherein the second communication comprises restoring RFID data to the transponder.

9. The computer program product of claim 1, wherein the first communication comprises restoring RFID data to the transponder.

10. The computer program product of claim 9, wherein the second communication comprises reading the restored RFID data from the transponder.

11. The computer program product of claim 1, wherein the first communication comprises reading the restored RFID data from the transponder.

12. The computer program product of claim 11, wherein the second communication comprises verifying the restored RFID data on the transponder.

13. A transponder communication system for providing a user with smart media output, wherein the smart media output includes at least one transponder attached to at least one media unit, said transponder communication system comprising:
a transponder interface; and
a user interface assembly,
wherein said user interface assembly is configured to communicate with said transponder interface to re-communicate with the transponder.

14. The transponder communication system of claim 13, wherein said transponder interface comprises at least one of a transponder encoder for encoding the transponder and a transponder reader for reading the transponder.

15. The transponder communication system of claim 13, further comprising a transponder control assembly, wherein said user interface assembly is configured to communicate with said transponder control assembly and said transponder control assembly is configured to communicate with said transponder interface to re-communicate with the transponder.

16. The transponder communication system of claim 13, wherein said user interface assembly communicates with said transponder interface to re-communicate with the transponder in response to a command entered by the user from said user interface assembly.

17. The transponder communication system of claim 15, wherein said user interface assembly communicates with said transponder control assembly and said transponder control assembly communicates with said transponder interface to re-communicate with the transponder in response to a command entered by the user from said user interface assembly.

18. The transponder communication system of claim 13, wherein said user interface assembly includes at least a display unit, and wherein said display unit is configured to display RFID data received from the transponder.

19. The transponder communication system of claim 3, wherein said transponder reader is configured to communicate with said display unit to display raw RFID data received from said transponder.

20. The transponder communication system of claim 19, wherein said RFID data is displayed in HEX format.

21. The transponder communication system of claim 13, wherein said user interface assembly includes at least a user interface panel, and wherein said user interface panel is configured to receive at least one command from the user.

22. The transponder communication system of claim 13, wherein said user interface assembly includes at least a display unit and a user interface panel, and wherein said display unit is configured to display RFID data received from the transponder and said user interface panel is configured to receive at least one command from the user.

23. The transponder communication system of claim 13, wherein said user interface assembly includes at least a display unit and a user interface panel, and wherein said display unit is configured to display communication errors communicated by said transponder interface.

24. The transponder communication system of claim 13, further comprising a printhead assembly and a printhead control assembly, wherein said printhead assembly is configured to print on the media unit.

25. A method of providing a user with smart media output, the smart media output including a transponder and a media unit, said method comprising:
communicating with the transponder via a transponder interface;
displaying RFID data received from the transponder on a display unit of a user interface assembly; and
re-communicating with the transponder in response to at least one command received from the user interface assembly.

26. The method of claim 25, wherein raw RFID data is displayed on the display unit.

27. The method of claim 26 wherein the RFID data is displayed in HEX format.

28. The method of claim 25 wherein said step of re-communicating with the transponder comprises at least one of reading, writing, restoring, and verifying RFID data.

29. The method of claim 25, wherein said step of re-communicating with the transponder occurs in response to at least one command entered by a user on a user interface panel of the user interface assembly.

30. The method of claim 29, wherein communication errors are displayed on the display unit when said step of communicating with the transponder is not successful.
